(19) United States
(12) Patent Application Publication
(10) Pub. No.: US 2025/0153224 A1
(43) Pub. Date: May 15, 2025

(54) Apparatus, System, and Method for Removal of Floating Vegetation

(71) Applicant: Cody Hood, Scottsboro, AL (US)

(72) Inventor: Cody Hood, Scottsboro, AL (US)

(21) Appl. No.: 18/507,261

(22) Filed: Nov. 13, 2023

(51) Int. Cl. B08B 3/02

(52) U.S. Cl. CPC B08B 3/02

(57) ABSTRACT

An apparatus for removal of floating vegetation away from a structure partially submerged in a body of water. The apparatus has a centrifugal pump with a radial impeller, an electrical motor of 2 to 4 horsepower, and an input pipe and output pipe, wherein the output of the centrifugal pump is at least 19,000 gallons of water per hour. The output pipe has one or more conduits connected thereto with a plurality of spray nozzles. The intake pipe and the output pipe each have at least a 3-inch diameter. The centrifugal pump takes water from the body of water through the input pipe and pumps it through the output pipe to the conduits and spray nozzles which are mounted below the structure and above the body of water. Water spray pumped through the spray nozzles pushes the floating vegetation away from the structure as long as the centrifugal pump is turned on and pumping.

### FIELD OF THE DISCLOSURE

This disclosure relates to an apparatus and system for removal of floating vegetation away from structures positioned in a body of water and, more particularly, to and apparatus and system for removal of floating vegetation away from structures positioned in water using a centrifugal pump to intake water from the body of water an expel it towards the floating vegetation.

### BACKGROUND OF THE DISCLOSURE

Vegetation grows along shorelines of lakes and ponds. Vegetation floats on the surface of water near the shoreline and encroaches upon structures in the water such as, for example, boat docks. Vegetation is a nuisance, and it is desirable to remove the vegetation away from the dock to facilitate boats leaving and entering the boat dock or to allow persons to swim near the boat dock. Cutting and removing the vegetation is not practical because the vegetation will regrow.

U.S. Pat. No. 7,867,390 discloses a system to direct vegetation away from structures partially submerged in water, using a plurality of conduits and a power actuated pump. The pump intakes the water and pumps it out through the nozzles of the conduits, thereby moving the vegetation away from the structure. The system is relatively complex and requires the use of a water intake filter to prevent interference with pump function. Filters require frequent cleaning or replacement. What is needed is a simpler system that does not require the use of water intake filters.

### SUMMARY OF THE DISCLOSURE

An apparatus is disclosed herein that provides for the removal of floating vegetation away from a structure partially submerged in a body of water near a shoreline. The apparatus has a centrifugal pump with an impeller, an input pipe, and an output pipe. The centrifugal pump has an electrical motor of, preferably, 2 to 4 horsepower. The output pipe has one or more conduits connected thereto, wherein the one or more conduits has a plurality of spray nozzles. The centrifugal pump, preferably, has a radial impeller. The intake pipe and the output pipe each have at least a 3-inch diameter. The output of the centrifugal pump is at least 19,000 gallons of water per hour.

A system for removal of floating vegetation away from a structure partially submerged in a body of water near a shoreline is disclosed herein. The system has a centrifugal pump mounted to the structure, wherein the centrifugal pump has an input pipe and an output pipe. The input pipe extends into the body of water and the output pipe extends to an underside of the structure. The output pipe connects to one or more conduits positioned below the underside of the structure and above the body of water. The conduits have a plurality of spray nozzles. The nozzles are constructed to spray water from the body of water towards the floating vegetation. The centrifugal pump is constructed to pump water from the body of water into the input pipe and to pump water from the input pipe out of the output pipe, through to the one or more conduits, and out through the spray nozzles, creating a water spray moving the floating vegetation away from the structure.

A method for removal of floating vegetation away from a structure partially submerged in a body of water near a shoreline is disclosed herein. A centrifugal pump is provided having an impeller, an input pipe, and an output pipe. The centrifugal pump has an electrical motor of 2 to 4 horsepower. The output pipe has one or more conduits connected thereto and the one or more conduits have a plurality of spray nozzles. The centrifugal pump is mounted to the structure, the input pipe is extended into the body of water and the output pipe is extended into an underside of the structure and above the body of water. The output pipe is connected to one or more conduits and the conduits are positioned below the underside of the structure and above the body of water. The centrifugal pump is turned on and water is pumped from the body of water into the input pipe. Water from the input pipe is pumped out of the output pipe, through to the one or more conduits, and out through the spray nozzles, thereby creating a water spray moving the floating vegetation away from the structure.

An advantage of the apparatus, system, and method of this disclosure is a pump system that surprisingly does not require a strainer on the input pipe positioned in the body of water, thereby reducing or eliminating the need for maintenance of the input pipe.

Another advantage is a centrifugal pump having a radial impeller and motor that provide resistance of the pump to fouling or clogging by debris in the body of water.

Another advantage is an apparatus and system that is inexpensive to construct and easy to implement and maintain.

### BRIEF DESCRIPTION OF THE DRAWINGS

FIG. 1 shows a top view of an exemplary apparatus and system of this disclosure for removal of floating vegetation away from a boat dock.

FIG. 2 shows a left side view of the apparatus and system of FIG. 1.

FIG. 3 shows a rear end view of the apparatus and system of FIG. 1.

### DETAILED DESCRIPTION OF THE DISCLOSURE

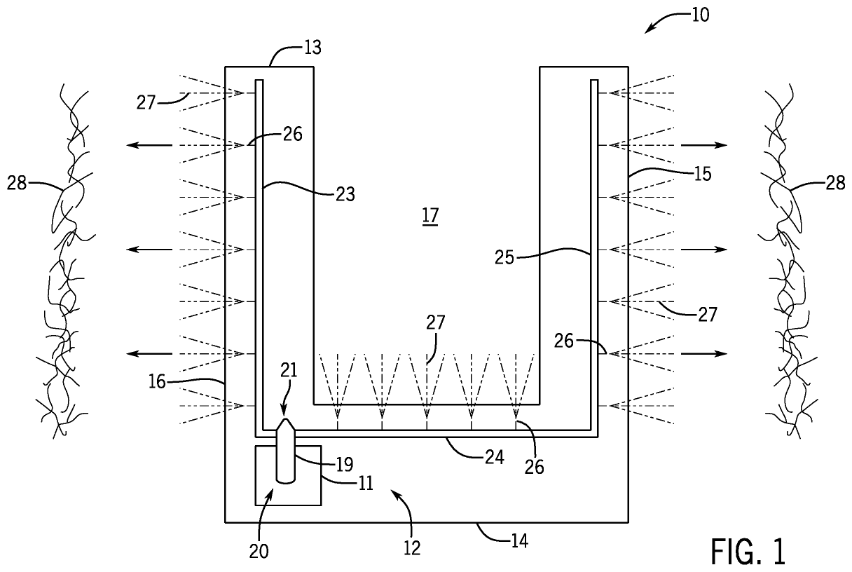

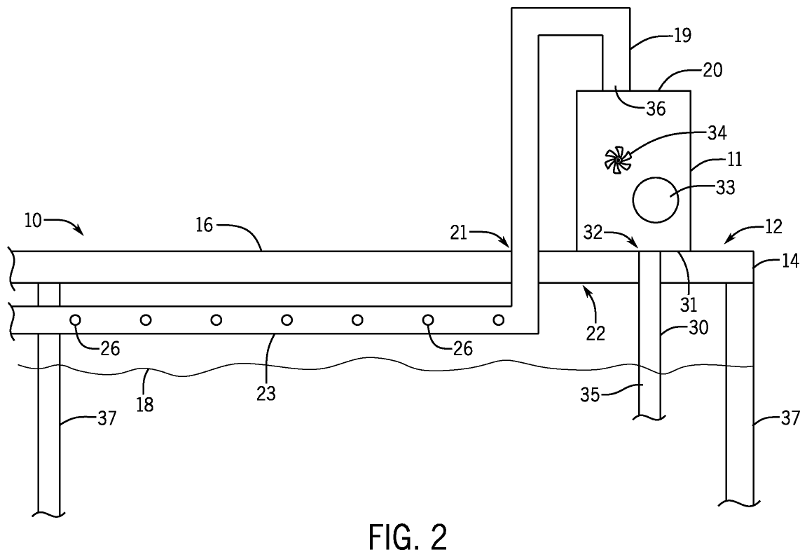

FIG. 1 shows, as an example of an apparatus and system of this disclosure, a boat dock 10 with a centrifugal pump 11 attached to a top surface 12 of the boat dock 10. The boat dock 10 has a front end 13, a rear end 14, a right side 15, a left side 16, and an interior 17 between the right side 15 and the left side 16 for receiving and securing a boat. The boat dock 10 is located partially in a body of water 18 (see FIG. 2).

The centrifugal pump 11 has an outflow pipe 19 on the top end 20 of the centrifugal pump 11. The outflow pipe 19 extends downward and through an opening 21 in the dock 10 to an underside 22 (see FIG. 2) of the dock 10. The outflow pipe 19 connects to conduit 23 under the dock 10. The conduit 23 extends along the left side 16 of the dock 10. The outflow pipe 19 also connects to a rear conduit 24 under the dock 10. The rear conduit 24 extends along the rear end 14 of the boat dock 10 and connects to a right side conduit 25 which extends along the right side 15 of the boat dock 10. The conduits 23, 24, and 25 are under the dock 10 and above the body of water 18 in which the dock 10 is located.

The conduits 23, 24, and 25 have a plurality of nozzles 26 that form a spray of water 27 when the centrifugal pump 11 pumps the water from the body of water 18 through the conduits 23, 24, and 25. The nozzles 26 direct the spray of water 27 towards floating vegetation and debris 28 that is encroaching upon the boat dock 10. The spray of water 27 pushes the vegetation and debris 28 away from the boat dock 10, as indicated by the arrows, and keeps the vegetation and debris 28 away from the dock 10 as long as the centrifugal pump 11 remains turned on.

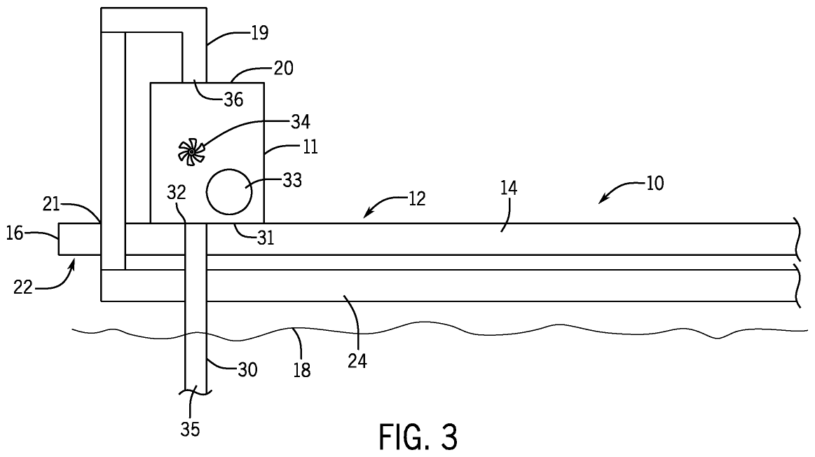

FIG. 2 shows a left side view of the floating vegetation removal system of this disclosure. FIG. 2 further shows the dock 10 has posts 37 supporting the dock 10 above the body of water 18. The centrifugal pump 11 has an input pipe 30 which extends from the bottom end 31 of the centrifugal pump 11 and which extends through an opening 32 in the dock 10 and into the body of water 18. The centrifugal pump 11 has, preferably, a radial impeller 34 and at least a three-inch diameter intake 35 and a three-inch diameter output 36. The centrifugal pump 11 has a 2-4 horsepower electric motor 33, preferably 3 horsepower. FIG. 3 shows a rear end view of the floating vegetation removal apparatus and system of this disclosure.

The apparatus and system of this disclosure can be constructed of any suitable plastic and/or metal. Conduits can have any desired configuration or orientation. The nozzles may be configured to direct the spray of water in any desired direction. The centrifugal pump can be placed anywhere on the top or underside of the dock. The centrifugal pump can be turned on or off automatically and/or remotely by methods known in the art.

The foregoing description illustrates and describes an apparatus and system of the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular application or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above to explain the nature of this invention may be made by those skilled in the art without departing from the principle and scope of the invention as recited in the following claims.

1. An apparatus for removal of floating vegetation away from a structure partially submerged in a body of water near a shoreline, comprising:
a) a centrifugal pump having an impeller, an input pipe, and an output pipe;
b) the centrifugal pump having an electrical motor of 2 to 4 horsepower; and
c) the output pipe having one or more conduits connected thereto, wherein the one or more conduits have a plurality of spray nozzles.

2. The apparatus of claim 1, wherein the centrifugal pump has a radial impeller.

3. The apparatus of claim 1, wherein the intake pipe and the output pipe each have at least a 3-inch diameter.

4. The apparatus of claim 1, wherein the output of the centrifugal pump is at least 19,000 gallons of water per hour.

5. The apparatus of claim 1, wherein the centrifugal pump has a radial impeller, wherein the intake pipe and the output pipe each have at least a 3-inch diameter, and wherein the output of the centrifugal pump is at least 19,000 gallons of water per hour.

6. A system for removal of floating vegetation away from a structure partially submerged in a body of water near a shoreline, comprising:
a) a centrifugal pump mounted to the structure, wherein the centrifugal pump has an input pipe and an output pipe;
b) the input pipe extending into the body of water and the output pipe extending to an underside of the structure, wherein the output pipe connects to one or more conduits positioned below the underside of the structure and above the body of water; and
c) the one or more conduits having a plurality of spray nozzles, wherein the spray nozzles are constructed to spray water from the body of water towards the floating vegetation.

7. The system of claim 6, wherein the centrifugal pump is constructed to pump water from the body of water into the input pipe and to pump water from the input pipe out of the output pipe, through to the one or more conduits, and out through the spray nozzles, creating a water spray moving the floating vegetation away from the structure.

8. The system of claim 6, wherein the centrifugal pump has a radial impeller.

9. The system of claim 6, wherein the intake pipe and the output pipe each have at least a 3-inch diameter.

10. The system of claim 6, wherein the output of the centrifugal pump is at least 19,000 gallons of water per hour.

11. The system of claim 6,
wherein the centrifugal pump is constructed to pump water from the body of water into the input pipe and to pump water from the input pipe out of the output pipe, through to the one or more conduits, and out through the spray nozzles, creating a water spray moving the floating vegetation away from the structure,
wherein the centrifugal pump has a radial impeller,
wherein the intake pipe and the output pipe each have at least a 3-inch diameter, and
wherein the output of the centrifugal pump is at least 19,000 gallons of water per hour.

12. A method for removal of floating vegetation away from a structure partially submerged in a body of water near a shoreline, comprising:
1. providing a centrifugal pump having an impeller, an input pipe, and an output pipe, wherein the centrifugal pump has an electrical motor of 2 to 4 horsepower, wherein the output pipe has one or more conduits connected thereto, and wherein the one or more conduits have a plurality of spray nozzles;
2. mounting the centrifugal pump to the structure, extending the input pipe into the body of water and extending the output pipe to an underside of the structure and above the body of water;
3. connecting the output pipe to one or more conduits and positioning the conduits below the underside of the structure and above the body of water; and
4. turning on the centrifugal pump and pumping water from the body of water into the input pipe, pumping water from the input pipe out of the output pipe, through to the one or more conduits, and out through the spray nozzles, and creating a water spray moving the floating vegetation away from the structure.

13. The method of claim 12, wherein the centrifugal pump has a radial impeller.

14. The method of claim 12, wherein the intake pipe and the output pipe each have at least a 3-inch diameter.

15. The method of claim 12, wherein the output of the centrifugal pump is at least 19,000 gallons of water per hour.

16. The method of claim 12, wherein the centrifugal pump has a radial impeller, wherein the intake pipe and the output pipe each have at least a 3-inch diameter, and wherein the output of the centrifugal pump is at least 19,000 gallons of water per hour.
